(19) United States
(12) Patent Application Publication
(10) Pub. No.: US 2002/0114220 A1
(43) Pub. Date: Aug. 22, 2002

(54) Appointment period calendar and reminder

(76) Inventor: Cristine Cassandra Cunningham, San Diego, CA (US)

Correspondence Address: CRISTINE CASSANDRA CUNNINGHAM, 4710 CLAIREMONT MESA BLVD, SAN DIEGO, CA, 92117, US

(21) Appl. No.: 10/076,236

(22) Filed: Feb. 12, 2002

Related U.S. Application Data
(60) Provisional application No. 60/270,312, filed on Feb. 20, 2001.

(51) Int. Cl. G04B 19/24

(52) U.S. Cl. 368/28

(57) ABSTRACT

This invention combines an appointment reminder with a novel calendar period. The portion of the normal calendar printed would always start with the month or week in which businesses distribute them to customers. The total period shown by the calendar will be one week to one month more than the period generally recommended for repetition of the service provided and will vary with the type of business giving them to customers. Space would be provided for printing of the contact and other data of such companies and for notation of the date and time of the next appointment. Space could also be provided for advertisements by other businesses. Magnetic devices could be adhesively attached to the material on which such novel calendar and appointment reminder was imprinted to enable removable attachment thereof to items containing ferrous materials.

### CROSS-REFERENCE TO RELATED APPLICATIONS

Not applicable.

### BACKGROUND

1. Field of Invention

This invention relates to calendars used for advertisement and appointment reminder purposes.

### BACKGROUND

2. Description of Prior Art

Calendars of normal periods, i.e. full years or months, are commonly printed upon printable media sheets or cards which sometimes include advertisements, contact information of some seller of goods or services, and such calendar period may be printed upon a single sheet or upon a group of such sheets padded so as to have contiguous pages reflect adjoining periods.

Generally speaking such calendars are not patentable per se because the printed calendar in common use, reflecting all the dates in a given month or full year, is commonly known and such calendars have been printed for centuries. A distinction is made for inventions which attempt to provide means of: (a) assembling “perpetual calendars”, e.g.

U.S. Pat. No. 5,799,423 to Malino, (b)combination card and calendar patents, e.g. U.S. Pat. Nos. 2,128,989. 2,228,517, and 3,605,306 issued to Dickerson, Hawkins, and Diambra respectively are utility patents with structures that all include folding of all of the parts (card, advertising area, and calendar) along parallel lines, (c) business appointment calendars such as reflected in U.S. Pat. No. 5,697,647 which involves a standard calendar year and removable appointment reminders to be given the customer, in which there is no provision for advertising information from other than the provider of the service nor for giving the customer any calendar of any type, (d) magnetically mounted postcards which may be imprinted with calendars or an appointment reminder such as is included under U.S. Pat. No. 5,983,537 to Johnson, and calendars showing normal monthly periods but in a holder which “improves” the utility of it as is reflected in U.S. Pat. No. 6,138,391 to Lung.

In none of the patents found, nor in an informal search of the market, has there been found any embodiment of a calendar period limited to a “normal appointment period”. A “normal appointment period” is one that will always commence with the “current period” and which ends after a period slightly longer than the time recommended by the applicable business type for customers to return for a like service. “Current period” is defined for use herein as that month or week in which the printed material containing the calendar period depicted is intended to be distributed to members of the consuming public. As an illustration but not by way of limitation to a given period or type of business, the recommendation of dentists that people commonly return in six months for another cleaning of the teeth would result in a calendar period totaling seven months commencing with the “current period”. Hereinafter the period commonly used in a given industry for performance of essentially the same service on a repeat basis will sometimes be called a “normal appointment period”.

The common printed calendar has date information far in excess of that needed to reflect most “normal appointment periods”. Prior months obviously serve no further functional use to the consumer or the business providing the service, being past. By reflection of a number of months or weeks beyond a “normal appointment period” the common calendar does not highlight the end of the time normally suggested for the customer to return for like services. By limiting the calendar period reflected to the applicable “normal appointment period” the end of that period and the need for an appointment will be highlighted. Reflecting only a “normal appointment period” instead of the usual 12 month fiscal or normal calendar often leaves a greater proportion of the total space available for use for advertising and for information pertaining to the provider of the services involved.

Flexible magnetic sheets, or portions thereof, have been adhesively affixed to the back of various items to enable removable attachment of such items to home appliances for many years. In the magnetically mounted postcards included in U.S. Pat. No. 5,983,537 such magnetic strips are incorporated into the “cards” by placing same between two strata composed either of two truly distinct strata or one strata folded so as to utilize one folded section as though it were a separate strata for purposes of the placement of such a magnet or magnets between two strata. In the invention claimed herein, when a magnet or a plurality of magnets is adhesively attached to a sheet of material on which is imprinted a “normal appointment period” calendar, only one strata touches the magnetic unit which is attached to the surface not depicting the said calendar thereby reducing the weight and the cost of production involved with magnetized calendars.

Appointment reminders are often provided by many businesses and have printed upon them the data pertaining to the identity and contact information pertinent to the business as well as a place for insertion of the date and time of the next appointment. Business appointment calendars such as reflected in U.S. Pat. No. 5,697,647 which involves two parts, one including a standard calendar year and the other part being removable appointment reminders to be given the customer, in which there is no provision for advertising information from other than the provider of the service nor for giving the customer any calendar of any type. No such appointment reminder is known to contain thereon a “normal appointment period” calendar as is contemplated herein. Neither do they provide space on which to place ads to targeted consumers, e.g. dental patients, which ads are given to such consumers by the entity providing service to such consumers, e.g. dentist, on a printed reminder which will ordinarily be kept and looked at a number of times and which implies that the service provider endorses the advertised products. This latter advantage is expected to serve as inducement to manufacturers to provide free appointment reminders of the type described herein to the service providers in the applicable industry.

### SUMMARY

This invention relates to the improvement of printed appointment reminders by including thereon a calendar period thereon limited to a period hereinafter called the “normal appointment period”. Said “normal appointment period” will always commence with the “current period” i.e. the week or month, depending upon the type of service involved, in which the reminder is intended to be distributed, and continue through an additional time period, day, week or, at most, one calendar month, beyond the “normal service cycle” in the given industry in which the given embodiment of the calendar and reminder is intended to be distributed. Unlike most normal calendars the “normal appointment period” may extend into a subsequent year but will never be for a standard twelve month period. “Normal service cycle” is defined to be the number of weeks or months between services of a type generally repeated in a given industry, e.g. teeth cleaning, hair dressing, auto lubrication, which services are given by way of illustration and not of limitation. The “normal appointment period” is thus a variable period as to the length thereof and can be modified to best suit the industry for which the appointment reminder card is prepared, e.g. seven months for dental appointments, seven weeks for beauty salon appointments or as members of such industry may suggest. By way of illustration but not limitation, assuming that dentists commonly recommend that a person return within, or shortly after, six months from the date his teeth are cleaned for the same service, the “appointment period” of the calendar distributed in April would commence with April 1 and could continue through October 31 by when the next appointment should have been made, while a calendar distributed in October, perhaps to the same customer, would extend from October 1 through April 30 of the subsequent year. A calendar designed for beauticians could commence with the current week and continue for a seven week period assuming that period reflected the time commonly used by beauticians for setting appointments for a repeated service such as a “styling”. Herein the uniquely designed period described in the prior sentence will sometimes be called a “normal appointment period”. By coincidence, the “normal appointment period” may sometimes begin or end with the same date as a common calendar depicting a single month or a full twelve month period. As with most appointment reminders it will include spaces for information about the provider of services to the consumer and insertion of an appointment date and time.

The limitation of the depicted calendar period to the “normal appointment period” may be of special utility to advertisers who wish to track the response to their advertisements since they can purchase advertisements solely for a given “normal appointment period”. Further, it has the advantage to the printer of creating a product which must be produced for each “normal appointment period” e.g. commencing with each month of the year for use by consumer service providers such as dentists and perhaps commencing with each week for use of consumer service providers such as beauticians. A further advantage to advertisers purchasing space on such printed “normal appointment period” calendars is that their advertisement is targeted to the special group of consumers to whom such combination “normal appointment period” calendar and appointment reminder are given by the service provider selected by such consumers.

The lapse of the calendar period depicted on such an appointment reminder concurrent with or shortly after the time set for an appointment within the “normal appointment period” will provide an additional reminder to the consumer of the need for calling for an appointment if the designated time set has been missed and a further incentive to the consumer to meet an appointment, i.e. to obtain printed material depicting calendar information beyond the termination of the “normal appointment period” calendar information contained on the lapsed appointment reminder.

Any printed material embodying one of the unique calendar periods envisioned herein could have one or more flexible magnetic devices attached to the back surface of the printed material to facilitate removable mounting to home appliances, automobiles, or any other surface to which magnets will adhere. Where such magnetic devices are incorporated with the printed sheet containing an appropriate “appointment period calendar”, an appointment reminder and contact information pertaining to the provider of the service involved, and an advertisement, the provider and the advertiser will obtain a direct market advertisement which is seen on a repeated basis when the unit is removably affixed to an appliance or other surface to which magnets will adhere and the consumer will be provided with a reminder to meet or obtain an appointment or otherwise arrange for a service to be provided within the “normal appointment period” depicted within the “appointment period calendar”. cl OBJECTS OF THE INVENTION

It is one of the primary objects of this invention to utilize a calendar in a new way and thereby provide a single printed device which can concurrently:

a. provide manufacturers of goods commonly used by customers regularly using specific types of services (1) a unique means of getting their advertising information and sales promotions directly to such customers via the entity actually providing related services to such customers (herein sometimes called “service provider”), e.g. dental care product manufacturers would be enabled to place advertising on appointment reminder cards distributed by dentists to their patients and (2) enable such manufacturers to track the impact of such advertisements by identifying a coupon or discount imprinted on such appointment reminder with the unique calendar period reflected on such appointment reminder.

b. provide service providers who generally perform certain types of services on a periodic basis with an appointment reminder containing a calendar which reflects the full applicable period between appointments for services of a recurring type without reflecting past months. These could be purchased directly from a printer licensed or employed to use this patent or received free from a manufacturer who may purchase the right to advertising on such “Appointment Period Calendars and Reminders” commencing with a specified period and which are to be sent to a specified number of service providers or for all such providers in a specified area.

c. Provide consumers of a provider of services which have a need which is reoccurring with an appointment reminder incorporating a calendar period which reminder will both explicitly, by the date and time noted thereon, and by the lapse of the unique period reflected on the calendar, remind the customer of the need to have the service repeated and provide such consumer with the contact information necessary to meet, confirm, or change such an appointment.

2. An ancillary objective is to make such reminders, together with the information regarding the service provider and the advertiser, if any, more prominent by using existing flexible magnetic sheet technology and affixing such magnets by adhesion to such appointment reminders so as to enable them to be removably affixed to home appliances, automobiles, and any other metal surface affected by magnetism.

3. An ancillary objective is to create a unique calendar which will lend itself to use by advertisers who may incorporate same with other advertising material, with or without contact information for specific providers of services, or space for such information, to be sent to a selected group as in the common advertising mailer or distributed document. As an example but not by way of limitation, generic reminders to contact their dentist for an appointment within the period shown on the “Appointment Period Calendar”.depicted in the printed material could be sent or distributed to selected consumers by manufacturers of dental care products without use of dentists to make such distribution.

### DRAWINGS

See the single page of Drawings submitted herewith.

FIG. 1 is a frontal top view of a representative appointment reminder which essentially is rectangular without any of the printed indicia thereon showing simply the front surface 1, the hidden back surface 3, the edge 5 and a hidden representative magnetic strip 7 affixed to the back surface 3.

FIG. 2 is a frontal bottom view of a representative appointment reminder intended to be the back or bottom view of that in FIG. 1 which essentially is rectangular without any of the printed indicia thereon showing simply the front surface 1, now hidden, the back surface 3, the edge 5 and a representative magnetic strip 7 affixed to the back surface 3.

FIG. 3 is a frontal top view of a representative appointment reminder reflecting thereon that space can be provided on the front surface 1 for (i) advertising, (ii) the relevant “Appointment Period Calendar” (iii) the appointment date and time and (iv) the name, telephone number and any other desired information pertinent to the provider of the service who distributes the reminder to the customer.

FIG. 4 is a frontal bottom view of the representative appointment reminder depicted in FIG. 3 reflecting that space can be provided for advertising material to be imprinted thereon.

### DRAWING SPECIFICATIONS

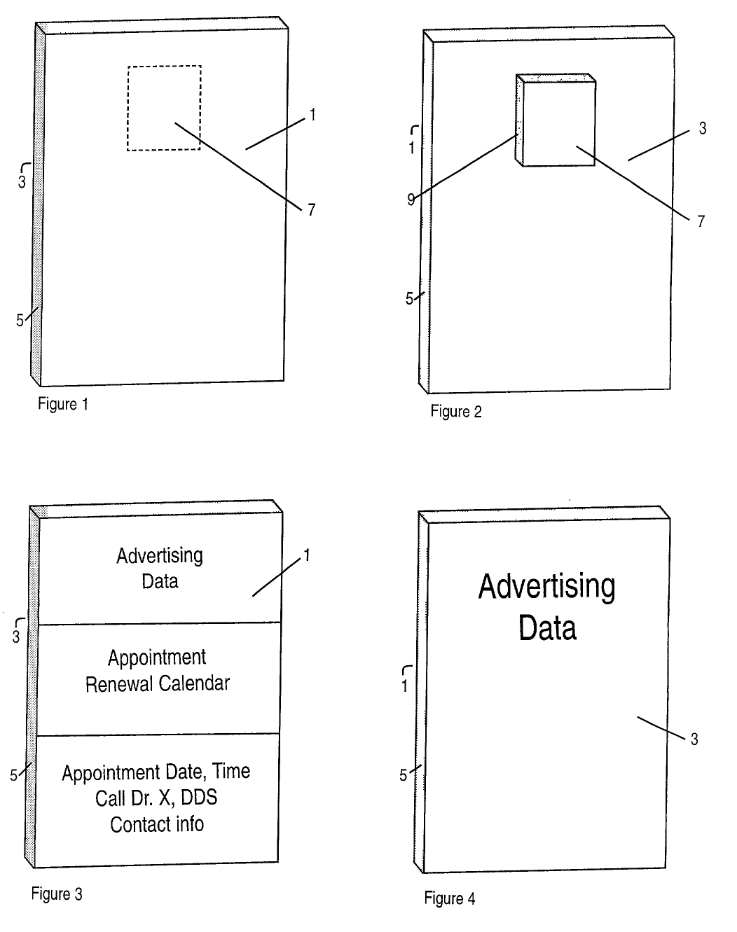

The material depicted in FIGS. 1 through 4 as limited to the surfaces identified as 1, 3 and 5, is essentially rectangular with surface dimensions, surfaces 1 and 3, being less than or equal to 11″×17″, whether measured vertically or horizontally, and with a thickness 5, which is less than one quarter of an inch. Said material is expected to commonly be described as “paper” but may be any material which is now, or which may subsequently be, in common use to reflect printed material thereon.

The material represented by 7 in FIGS. 1 and 2 is composed of any magnetic material which can be adhesively attached to the material on which the imprinted data is placed prior to such attachment. Said adhesion may be separately applied at the time of attachment or may be included by the seller of the magnetic material, e.g. be adhesion provided on the back of flexible magnetic sheets or portions thereof. Said magnetic material may be in any shape and size and may be adhesively attached to the back, surface 3 as per said figures, in single or multiple units with the total surface area of the top or bottom of such magnetic material which is so attached being less than the total surface area of said surface 3 and of a thickness 9 which is less than one half inch but being of a total size adequate to removably attach, by magnetic forces, the entire said magnet and the printed material to which it is adhesively attached, i.e. the Appointment Period Calendar and Reminder, to a surface with ferrous material therein, e.g. a refrigerator.

### Reference Numerals in Drawings

1. One surface of a strata suitable for printing.

3. The surface of such strata 180° from 1.

5. The thickness of such strata with surfaces 1 and 3.

7. Magnetic material with a thickness 9.

Having so described the invention, what I desire to claim and secure by Letters Patent is:

1. A new use of the normal printed calendar currently in common use in the United States and Europe by limiting the period reflected to one herein sometimes called the “normal appointment period ” which “normal appointment period” always starts with a period selected from a category which includes a day, a week, and a month, which selected starting period is the same as the period in which the printed material containing same is to be distributed, and which “appointment period” continues to the end of a calendar period which varies according to the practices of the applicable industry regarding the time commonly recommended for providing like services on a periodic basis, going into the next calendar year if the total period to be reflected, being a maximum of thirteen months and as little as three weeks as measured from the commencement date of the calendar period used, extends into the subsequent calendar year. Any printed calendar depicting any such limited “appointment period” is sometimes termed an “Appointment Period Calendar” herein.

2. A printed appointment reminder incorporating an appropriate “Appointment Period Calendar”, called an “Appointment Period Calendar and Reminder” herein and composed of:
a) a sheet which has a top surface, a bottom surface, and a thickness which may vary but is commonly anticipated as being less than one quarter of an inch and which sheet is made of a material that is capable of and is often used for the purposes of printing information thereon, e.g. paper.
b) Space on the top surface for informational data respecting the entity giving said appointment reminder to a customer including but not limited to the name, address, and telephone number thereof.
c) Space on the top surface for inserting the date and time of the next appointment for a service to be provided to the customer receiving the said appointment reminder by the said entity giving said appointment reminder to a customer.
d) Space on the top and on the bottom surface for advertising to be imprinted thereon
e) Space for imprinting on the said top surface of a “normal appointment period” as described in claim 1 above. The novel calendar period depicted may sometime herein be termed an “Appointment Period Calendar” and will always commence with the current month or week in which the appointment reminder containing it is to be distributed, and terminate no more than a month after a period which includes the date commonly set in the particular type of business distributing such appointment reminder for the next appointment whether that period extends into the next calendar year or not. Included on any portion of the same area provided for such “Appointment Period Calendar”, e.g. in one or more of the date blocks common to calendars may be places for printing information such as, for example and not by way of limitation: (i) reminding the user to contact the service provider about an appointment; (ii) suggesting use of products of the advertiser.

3. The appointment reminder described in claim 2., excepting all the matter set out in 2. e) and substituting therefore
f) space on the said top surface for affixing thereto by adhesion or other means such as stapling of a number of sheets each with a top surface, a bottom surface and an edge equal to the thickness thereof and which collectively have space for imprinting on the top surfaces thereof of a “normal appointment period” as described in claim 1 above. The novel calendar period depicted may sometime herein be termed a “Appointment Period Calendar” and will commence with the current month or week in which the appointment reminder containing it is distributed, and terminate no more than a month after a period which includes the date commonly set in the particular type of business distributing such appointment reminder for the next appointment whether that period extends into the next calendar year or not. Included on any portion of the same area provided for such “Appointment Period Calendar”, e.g. in one or more of the date blocks common to calendars, may be places for printing information such as, for example and not by way of limitation: (i) reminding the user to contact the service provider about an appointment; (ii) suggesting use of products of the advertiser. Said sheets will be placed in calendar date order and padded by some means common in the print industry, e.g. glue or stitching . Each said sheet will have space on the top surface thereof for one or more days of the appropriate novel calendar period and on the top and bottom surface thereof for advertising information and other indicia as may be desired.

4. The appointment reminder as described in claim 2 further characterized by providing spaces on the said back surface for one or a plurality of flexible magnetic devices of one or more geometric shapes to be affixed thereto by an adhesive either pre-applied to the magnetic material or applied at some time subsequent to the printing of the pertinent data upon the first and second surfaces of a selected number of such appointment reminders with the total surface area of that side of such magnetic devices as is to be adhesively attached to the appointment reminder not exceeding the surface area to which same are to be attached.

5. The appointment reminder as described in claim 3 further characterized by providing spaces on the said back surface for one or a plurality of flexible magnetic devices of one or more geometric shapes to be affixed thereto by an adhesive either pre-applied to the magnetic material or applied at some time subsequent to the printing of the pertinent data upon the first and second surfaces of a selected number of such surfaces with the total surface area of that side of such magnetic devices as is to be adhesively attached to the appointment reminder not exceeding the surface area to which same are attached.
